(19) United States
(12) Patent Application Publication
(10) Pub. No.: US 2026/0024805 A1
(43) Pub. Date: Jan. 22, 2026

(54) SOLID-STATE BATTERY

(71) Applicants: TOYOTA JIDOSHA KABUSHIKI KAISHA, Toyota-shi (JP); PANASONIC HOLDINGS CORPORATION, Osaka (JP)

(72) Inventors: Akio Mitsui, Anjo-shi (JP); Kazuya Otsu, Miyoshi-shi (JP); Kenji Nagao, Moriguchi-shi (JP); Yusuke Ito, Kashihara-shi (JP); Izuru Sasaki, Kyoto-shi (JP); Akio Kaneyama, Hirakata-shi (JP)

(73) Assignees: TOYOTA JIDOSHA KABUSHIKI KAISHA, Toyota-shi (JP); PANASONIC HOLDINGS CORPORATION, Osaka (JP)

(21) Appl. No.: 19/270,066

(22) Filed: Jul. 15, 2025

(30) Foreign Application Priority Data
Jul. 17, 2024 (JP) 2024-114147

(51) Int. Cl. H01M 10/0562; H01M 4/02; H01M 4/04; H01M 10/0525; H01M 10/0585

(52) U.S. Cl. CPC H01M 10/0562; H01M 4/0404; H01M 4/043; H01M 4/0471; H01M 10/0525; H01M 10/0585; H01M 2004/021

(57) ABSTRACT

A solid-state battery includes an electrode laminate body in which a positive electrode active material layer, a solid electrolyte layer, and a negative electrode active material layer are laminated in this order, in which: each of the positive electrode active material layer, the solid electrolyte layer, and the negative electrode active material layer contains a sulfide solid electrolyte; a surface moisture amount of the electrode laminate body is 200 ppm to 1500 ppm; and the ratio of the surface moisture amount to a whole moisture amount in the whole of the electrode laminate body is 0.50 to 1.00.

### CROSS-REFERENCE TO RELATED APPLICATION

This application claims priority to Japanese Patent Application No. 2024-114147 filed on Jul. 17, 2024. The disclosure of the above-identified application, including the specification, drawings, and claims, is incorporated by reference herein in its entirety.

### BACKGROUND

### 1. Technical Field

The present disclosure relates to a solid-state battery.

### 2. Description of Related Art

A solid-state battery is a secondary battery that includes a solid electrolyte as the electrolyte, and has attracted attention because the solid-state battery has a higher safety than a liquid battery in which an electrolytic solution is used as the electrolyte. Various developments have been performed for the improvement in the output of the solid-state battery, and an electrochemical element containing a solid electrolyte described below has been known.

WO 2018/026009 discloses an electrochemical element including a laminate body that includes a positive electrode, a negative electrode, and a solid electrolyte sandwiched between the positive electrode and the negative electrode. The laminate body contains moisture, and the amount of the moisture contained in the laminate body is 0.001 mass % or more and less than 0.3 mass % with respect to the laminate body. With the electrochemical element in WO 2018/026009, it is possible to maintain the operation when a high voltage is applied.

### SUMMARY

The present disclosure has an object to provide a solid-state battery that makes it possible to decrease the resistance increase rate of the battery based on durability without significantly increasing the direct-current resistance in an initial period.

The present disclosure achieves the above object in the following ways.

### Aspect 1

A solid-state battery including an electrode laminate body in which a positive electrode active material layer, a solid electrolyte layer, and a negative electrode active material layer are laminated in this order, wherein:
each of the positive electrode active material layer, the solid electrolyte layer, and the negative electrode active material layer contains a sulfide solid electrolyte;
a surface moisture amount of the electrode laminate body is 200 ppm to 1500 ppm; and
a ratio of the surface moisture amount to a whole moisture amount in a whole of the electrode laminate body is 0.50 to 1.00.

### Aspect 2

The solid-state battery according to aspect 1, wherein the surface moisture amount of the electrode laminate body is 200 ppm to 600 ppm.

### Aspect 3

A method of producing the solid-state battery according to aspect 1 or 2, the method including:
(a) providing a preliminary electrode laminate body in which the positive electrode active material layer, the solid electrolyte layer, and the negative electrode active material layer are laminated in this order; and
(b) generating the electrode laminate body by keeping the preliminary electrode laminate body for 30 seconds or more in an environment in which a dew point is −80° C. or higher and 0° C. or lower, and causing the preliminary electrode laminate body to adsorb moisture.

### Aspect 4

The method according to aspect 3, the method further including, between (a) and (b),
(a-2) pressing the preliminary electrode laminate body at a temperature of 100° C. or higher and 200° C. or lower.

### Aspect 5

The method according to aspect 3 or 4, the method further including, after (b),
(b-2) forming a preliminary solid-state battery by disposing a current collector layer on a surface of the electrode laminate body; and
(b-3) pressing the preliminary solid-state battery at a temperature of 100° C. or higher and 200° C. or lower.

With the solid-state battery in the present disclosure, it is possible to decrease the resistance increase rate of the battery based on durability without significantly increasing the direct-current resistance in an initial period.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic sectional view for describing a solid-state battery in the present disclosure;

FIG. 2A is an exemplary schematic sectional view for describing a method of producing the solid-state battery in the present disclosure;

FIG. 2B is another exemplary schematic sectional view for describing the method of producing the solid-state battery in the present disclosure;

FIG. 2C is another exemplary schematic sectional view for describing the method of producing the solid-state battery in the present disclosure;

FIG. 3A is an exemplary schematic sectional view for describing the method of producing the solid-state battery in the present disclosure;

FIG. 3B is another exemplary schematic sectional view for describing the method of producing the solid-state battery in the present disclosure; and

FIG. 4 is a graph showing the relation of a surface moisture amount, initial direct-current resistance, and resistance increase rate for solid-state batteries in examples and a comparative example.

### DETAILED DESCRIPTION OF EMBODIMENTS

An embodiment of the present disclosure will be described below in detail. The present disclosure is not limited to the embodiment described below, and can be carried out while being variously modified within the scope of the spirit of the present disclosure. Further, in the description of the drawings, identical elements are denoted by identical reference characters, and repetitive descriptions are omitted.

In the present disclosure, a “composite material” means a composition that can compose an electrode active material layer or the like by itself or by further containing another component. Further, in the present disclosure, a “composite material slurry” means a slurry that contains a dispersion medium in addition to the “composite material” and thereby can form the electrode active material layer or the like by applying and drying.

In the present disclosure, a “solid-state battery” means a battery in which at least a solid electrolyte is used as the electrolyte, and accordingly, in the solid-state battery, a combination of the solid electrolyte and a liquid electrolyte may be used as the electrolyte. Further, the solid-state battery in the present disclosure may be an all-solid-state battery, that is, a battery in which only the solid electrolyte is used as the electrolyte.

### Solid-State Battery

A solid-state battery in the present disclosure includes an electrode laminate body in which a positive electrode active material layer, a solid electrolyte layer, and a negative electrode active material layer are laminated in this order,
each of the positive electrode active material layer, the solid electrolyte layer, and the negative electrode active material layer contains a sulfide solid electrolyte,
a surface moisture amount of the electrode laminate body is 200 ppm to 1500 ppm, and
the ratio of the surface moisture amount to a whole moisture amount in the whole of the electrode laminate body is 0.50 to 1.00.

With the solid-state battery in the present disclosure, it is possible to decrease the resistance increase rate of the battery based on durability without significantly increasing the direct-current resistance in an initial period.

Regarding the electrode laminate body containing the sulfide solid electrolyte, the inventors have found that the moisture amount on the surface of the electrode laminate body, the direct-current resistance in an initial period, and the resistance increase rate have the following relation. As the relation, when the surface moisture amount of the electrode laminate body increases, the resistance increase rate of the solid-state battery based on durability is reduced (that is, the direct-current resistance of the solid-state battery easily decreases due to durability), and on the other hand, the direct-current resistance in the initial period increases.

Further, the inventors have found that the effect of reducing the resistance increase rate of the solid-state battery based on durability (that is, the effect of easily decreasing the direct-current resistance of the solid-state battery due to durability) can be obtained only in the case where the ratio of the surface moisture amount to the whole moisture amount in the whole of the electrode laminate body is high.

Based on the knowledge, the inventors have conceived of a solid-state battery that makes it possible to obtain the effect of reducing the resistance increase rate of the solid-state battery based on durability (that is, the effect of easily decreasing the direct-current resistance of the solid-state battery due to durability) without significantly increasing the direct-current resistance in the initial period, by appropriately controlling “the surface moisture amount” of the electrode laminate body and “the ratio of the surface moisture amount to the whole moisture amount of the electrode laminate body”.

Although not limited to any theory, it is presumed that when the electrode laminate body in which each of the positive electrode active material layer, the solid electrolyte layer, and the negative electrode active material layer contains the sulfide solid electrolyte adsorbs a predetermined amount of surface moisture, the surface moisture adsorbed in the electrode laminate body permeates to an interface between the positive electrode active material and the solid electrolyte, a reaction layer having a moderate thickness is formed at the interface, and the oxidative decomposition of the sulfide solid electrolyte at the time of charge is inhibited by the reaction layer, so that it is possible to decrease the resistance increase rate based on durability without significantly increasing the direct-current resistance in the initial period.

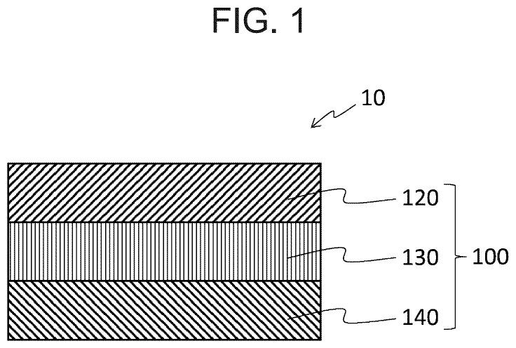

FIG. 1 is a schematic sectional view showing an aspect of the solid-state battery in the present disclosure, although not limited to this case.

A solid-state battery 10 includes an electrode laminate body 100 in which a positive electrode active material layer 120, a solid electrolyte layer 130, and a negative electrode active material layer 140 are laminated in this order. Each of the positive electrode active material layer 120, the solid electrolyte layer 130, and the negative electrode active material layer 140 contains the sulfide solid electrolyte. The surface moisture amount of the electrode laminate body 100 is 200 ppm to 1500 ppm, and the ratio of the surface moisture amount to the whole moisture amount in the whole of the electrode laminate body 100 is 0.50 to 1.00. The electrode laminate body containing sulfide contains the surface moisture amount in a predetermined range, and thereby, it is possible to decrease the resistance increase rate based on durability without significantly increasing the direct-current resistance in the initial period.

### Moisture Amount of Electrode Laminate Body

### Surface Moisture Amount

In the solid-state battery in the present disclosure, the surface moisture amount of the electrode laminate body is 200 ppm to 1500 ppm, and preferably should be 200 ppm to 600 ppm. For example, the surface moisture amount may be 200 ppm or more, 220 ppm or more, or 240 ppm or more, and may be 1500 ppm or less, 1200 ppm or less, 900 ppm or less, or 600 ppm or less.

In the present disclosure, the “surface moisture amount” can be evaluated by the following method. First, the electrode laminate body is punched such that 20 pieces having ϕ9.2 mm are obtained, and is taken in a Karl Fischer device (Karl Fischer device CA-310 and moisture vaporization device VA-300 manufactured by NITTOSEIKO CO., LTD.). Next, the electrode laminate body after punching is put in the moisture vaporization device VA-300 previously heated to 200° C., the moisture amount desorbed from the electrode laminate body by heating is measured by the Karl Fischer device CA-310, and the obtained moisture amount is adopted as the surface moisture amount. The measurement is ended when the detected moisture amount becomes 0.02 μg/sec or less. The surface moisture amount is a moisture amount that is obtained by measurement while the lamination structure of the electrode laminate body is maintained, and is thought to be mainly a moisture amount that is desorbed from the surface of the electrode laminate body.

### Ratio of Surface Moisture Amount to Whole Moisture Amount

In the solid-state battery in the present disclosure, the ratio of the surface moisture amount to the whole moisture amount in the whole of the electrode laminate body is 0.50 to 1.00. For example, the above ratio may be 0.50 or more, 0.70 or more, or 0.90 or more, and may be 1.00 or less, 0.99 or less, or 0.98 or less. The ratio of the surface moisture amount to the whole moisture amount can be calculated from the whole moisture amount described later and the above surface moisture amount.

In the present disclosure, the “whole moisture amount” can be evaluated by the following method. First, the electrode laminate body is ground in a mortar, and the powder obtained by grinding is taken in the Karl Fischer device (Karl Fischer device CA-310 and moisture vaporization device VA-300 manufactured by NITTOSEIKO CO., LTD.). Next, the above powder is put in the moisture vaporization device VA-300 previously heated to 200° C., the moisture amount desorbed from the above powder by heating is measured by the Karl Fischer device CA-310, and the obtained moisture amount is adopted as the whole moisture amount. The measurement is ended when the detected moisture amount becomes 0.02 g/sec or less. The whole moisture amount is a moisture amount that is obtained by grinding the electrode laminate body and measuring the obtained powder, and is thought to be a moisture amount that is desorbed from the whole including the interior of the electrode laminate body.

### Configuration of Electrode Laminate Body

In the solid-state battery in the present disclosure, in the electrode laminate body, the positive electrode active material layer, the solid electrolyte layer, and the negative electrode active material layer are laminated in this order. For example, the electrode laminate body may include a positive electrode current collector layer and a negative electrode current collector layer. Although not particularly limited, the electrode laminate body preferably should include the positive electrode active material layer, the solid electrolyte layer, the negative electrode active material layer, the negative electrode current collector layer, the negative electrode active material layer, the solid electrolyte layer, and the positive electrode active material layer, in this order, and more preferably should include the positive electrode current collector layer, the positive electrode active material layer, the solid electrolyte layer, the negative electrode active material layer, the negative electrode current collector layer, the negative electrode active material layer, the solid electrolyte layer, the positive electrode active material layer, and the positive electrode current collector layer, in this order.

### Positive Electrode Current Collector Layer

Examples of the material that is used in the positive electrode current collector layer include Cu, Ni, Cr, Au, Pt, Ag, Al, Fe, Ti, Zn, Co, and stainless steel, but are not limited to them. Further, the positive electrode current collector layer may include some kind of coat layer on a surface thereof, for the purpose of resistance regulation or the like. Further, the positive electrode current collector layer may be a positive electrode current collector layer in which the above metal is provided on a metal foil or a base material by plating or deposition.

Although not particularly limited, examples of the shape of the positive electrode current collector layer include a foil shape, a plate shape, and a mesh shape. Among them, the foil shape is preferable. Although not particularly limited, the thickness of the positive electrode current collector layer may be 0.1 μm or more, or 1 μm or more, and may be 1 mm or less, or 100 μm or less.

### Positive Electrode Active Material Layer

The positive electrode active material layer contains at least a positive electrode active material and the sulfide solid electrolyte, and optionally, may further contain a conduction aid, a binder, or the like. The respective contents of the positive electrode active material, sulfide solid electrolyte, conduction aid, binder, and others in the positive electrode active material layer may be appropriately decided depending on an intended battery performance.

### Positive Electrode Active Material

The material of the positive electrode active material is not particularly limited, as long as lithium ions can be stored and released. The positive electrode active material may be lithium cobalt oxide (LiCoO₂), lithium nickel oxide (LiNiO₂), lithium manganese oxide (LiMn₂O₄), lithium nickel-cobalt-manganese oxide (NCM: LiCOₓNi_{y}Mn_{z}O₂), or lithium nickel-cobalt-aluminum oxide (LiNi_{0.8}(CoAl)_{0.2}O₂), for example, but is not limited to them.

Although not particularly limited, the positive electrode active material may include a covering layer. The covering layer is a layer having lithium-ion conduction performance, and is a layer containing a substance that has a low reactivity with the positive electrode active material and the solid electrolyte and that makes it possible to maintain the form of the covering layer without flowing even in the case of the contact with the active material or the solid electrolyte. Specific examples of the material composing the covering layer include LiNbO₃, Li₄Ti₅O₁₂, Li₃PO₄, and Li—Ti—Al—F materials, but are not limited to them.

The shape of the positive electrode active material is not particularly limited, and may be a particle shape. For example, an average particle diameter D₅₀ of the positive electrode active material may be 1 nm or more, 5 nm or more, or 10 nm or more, and may be 500 μm or less, 100 μm or less, 50 μm or less, or 30 μm or less. The average particle diameter D₅₀ is a particle diameter (median diameter) at an integrated value of 50% in a volume-basis particle size distribution that is evaluated by a laser diffracting-scattering method.

### Sulfide Solid Electrolyte

Examples of the sulfide solid electrolyte include a sulfide amorphous solid electrolyte, a sulfide crystalline solid electrolyte, and an argyrodite solid electrolyte, but are not limited to them. Specific examples of the sulfide solid electrolyte particle include a Li₂S—P₂S₅ series (Li₇P₃S₁₁, Li₃PS₄, Li₈P₂S₉, and the like), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃Si₆, Li₁₀GeP₂S₁₂, and the like), LiI—Li₂S—P₂O₅, LiI—Li₃PO₄—P₂S₅, Li₇₋ₓPS₆₋ₓClₓ, and combinations of them, but are not limited to them. Although not particularly limited, the sulfide solid electrolyte may be a glass or may be a crystallized glass (glass ceramics).

### Optional Component—Conduction Aid

The conduction aid may be vapor-grown carbon fiber (VGCF), acetylene black (AB), Ketchen black (KB), carbon nanotube (CNT), carbon nanofiber (CNF), or conductive carbon, for example, but is not limited to them. The conduction aid may have a particle shape or a fiber shape, for example, and the size is not particularly limited. Although not particularly limited, for the conduction aid, only one kind may be used alone, or two or more kinds may be combined and used.

### Optional Component—Binder

The binder may be a material, such as polyvinylidene fluoride (PVdF), butadiene rubber (BR), polytetrafluoroethylene (PTFE), or styrene-butadiene rubber (SBR), for example, but is not limited to them. Although not particularly limited, for the binder, only one kind may be used alone, or two or more kinds may be combined and used.

Although not particularly limited, for example, the thickness of the positive electrode active material layer may be 0.1 μm or more, 1 μm or more, or 10 μm or more, and may be 2 mm or less, 1 mm or less, or 500 μm or less.

The positive electrode active material layer can be easily shaped, for example, by shaping a positive electrode composite material containing the above various components, by a dry system or a wet system. The positive electrode active material layer may be shaped together with the positive electrode current collector layer, or may be shaped separately from the positive electrode current collector layer.

### Solid Electrolyte Layer

The solid electrolyte layer contains at least a sulfide solid electrolyte, and may contain a conduction aid, a binder, or the like, as necessary. As for the sulfide solid electrolyte, the conduction aid, and the binder, the above description in “Positive Electrode Active Material Layer” can be referred to.

Although not particularly limited, for example, the thickness of the solid electrolyte layer may be 0.1 μm or more, 1 μm or more, or 10 μm or more, and may be 2 mm or less, 1 mm or less, or 500 μm or less.

The solid electrolyte layer can be easily shaped, for example, by shaping a solid electrolyte composite material containing the above-described solid electrolyte, the binder, and the like, by a dry system or a wet system.

### Negative Electrode Active Material Layer

The negative electrode active material layer contains at least a negative electrode active material and the sulfide solid electrolyte, and optionally, may further contain a conduction aid, a binder, or the like. As for the sulfide solid electrolyte, conduction aid, and binder that can be contained in the negative electrode active material layer, the above description in “Positive Electrode Active Material Layer” can be referred to. The respective contents of the negative electrode active material, sulfide solid electrolyte, conduction aid, binder, and others in the negative electrode active material layer may be appropriately decided depending on an intended battery performance.

### Negative Electrode Active Material

As the negative electrode active material, various substances that are lower than the positive electrode active material in an electric potential (charge-discharge potential) at which lithium ions are stored and released can be employed. The material of the negative electrode active material is not particularly limited, and may be metal lithium, or may be a material that can store and release metal ions, such as lithium ions. The material that can store and release metal ions, such as lithium ions is not particularly limited, and there are an alloy negative electrode active material, a carbon material, lithium titanium oxide (Li₄Ti₅O₁₂), and the like. Examples of the alloy negative electrode active material include an Si alloy negative electrode active material and an Sn alloy negative electrode active material, but are not limited to them. Examples of the carbon material include hard carbon, soft carbon, and graphite, but are not limited to them.

For example, the shape of the negative electrode active material may be a particle shape, or may be a sheet shape.

Although not particularly limited, for example, the thickness of the negative electrode active material layer may be 0.1 μm or more, 1 μm or more, or 10 μm or more, and may be 2 mm or less, 1 mm or less, or 500 μm or less.

The negative electrode active material layer can be easily shaped, for example, by shaping a negative electrode composite material containing the above various components, by a dry system or a wet system. The negative electrode active material layer may be shaped together with the negative electrode current collector layer, or may be shaped separately from the negative electrode current collector layer.

### Negative Electrode Current Collector Layer

Examples of the material that is used in the negative electrode current collector layer include Cu, Ni, Cr, Au, Pt, Ag, Al, Fe, Ti, Zn, Co, stainless steel, and carbon sheet, but are not limited to them. The negative electrode current collector layer may include some kind of coat layer on a surface thereof, for the purpose of resistance regulation or the like.

Although not particularly limited, examples of the shape of the negative electrode current collector layer include a foil shape, a plate shape, and a mesh shape. Among them, the foil shape is preferable. Although not particularly limited, the thickness of the negative electrode current collector layer may be 0.1 μm or more, or 1 μm or more, and may be 1 mm or less, or 100 μm or less.

### Configuration of Solid-State Battery

Although not particularly limited, the solid-state battery may further include the positive electrode current collector layer and the negative electrode current collector layer, as necessary. As for the positive electrode current collector layer and the negative electrode current collector layer, the above description in “Configuration of Electrode Laminate Body” can be referred to.

Although not particularly limited, the solid-state battery may be enclosed by a laminate film. Further, although not particularly limited, the solid-state battery may be confined at a confining pressure of 5 MPa, for example.

### Shape and Others of Solid-State Battery

Examples of the shape of the solid-state battery include a coin type, a laminate type, a cylinder type, and a rectangle type, but are not limited to them.

### Use Application and Others of Solid-State Battery

The solid-state battery in the present disclosure may be a lithium-ion secondary battery, for example. Further, for example, the solid-state battery in the present disclosure may be an in-vehicle battery, may be used as an electric power source of a moving body (for example, a train, a ship, or an airplane) other than a vehicle, or may be used as an electric power source of an electric product, such as an information processing device.

### Method of Producing Solid-State Battery

The solid-state battery in the present disclosure can be produced by a method including the following steps.
(a) providing a preliminary electrode laminate body in which the positive electrode active material layer, the solid electrolyte layer, and the negative electrode active material layer are laminated in this order, and
(b) generating an electrode laminate body by keeping the preliminary electrode laminate body for 30 seconds or more in an environment in which the dew point is −80° C. or higher and 0° C. or lower, and causing the preliminary electrode laminate body to adsorb moisture.

With the method of producing the solid-state battery in the present disclosure, it is possible to produce a battery that makes it possible to decrease the resistance increase rate of the battery based on durability without significantly increasing the direct-current resistance in the initial period.

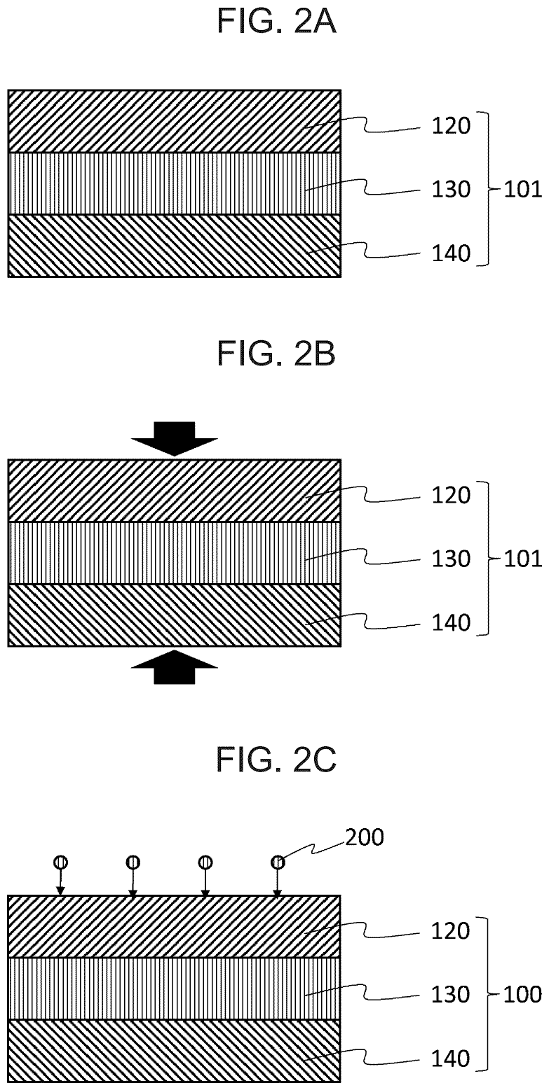

FIG. 2A, FIG. 2B, and FIG. 2C are schematic sectional views showing an aspect of the method of producing the solid-state battery in the present disclosure, although not limited to this case.

First, as shown in FIG. 2A, a preliminary electrode laminate body 101 in which the positive electrode active material layer 120, the solid electrolyte layer 130, and the negative electrode active material layer 140 are laminated in this order is provided. As a method of providing the preliminary electrode laminate body 101, for example, solid electrolyte layers are laid over respective surfaces of negative electrode active material layers formed on both surfaces of a negative electrode current collector layer, and are pressed. Thereby, the solid electrolyte layers are transferred to the surfaces of the negative electrode active material layers, and the solid electrolyte layers are laminated on the negative electrode active material layers. Next, positive electrode active material layers are laid over respective surfaces of the solid electrolyte layers laminated on both surfaces of the negative electrode active material layers, and are pressed. Thereby, the positive electrode active material layers are transferred to the surfaces of the solid electrolyte layers, and the positive electrode active material layers are laminated on the solid electrolyte layers, so that it is possible to provide a preliminary electrode laminate body in which the positive electrode active material layer, the solid electrolyte layer, the negative electrode active material layer, the negative electrode current collector layer, the negative electrode active material layer, the solid electrolyte layer, and the positive electrode active material layer are laminated in this order. Moreover, as shown in FIG. 2C, the preliminary electrode laminate body 101 is kept for 30 seconds or more in an environment in which the dew point is −80° C. or higher and 0° C. or lower, and is caused to adsorb moisture 200, so that an electrode laminate body 100 is generated. Moreover, the solid-state battery 10 can be produced using the electrode laminate body 100.

Although not particularly limited, the method of producing the solid-state battery in the present disclosure may further include, between (a) and (b),
(a-2) pressing the preliminary electrode laminate body at a temperature of 100° C. or higher and 200° C. or lower.

In the above-described FIG. 2A, FIG. 2B, and FIG. 2C, first, the preliminary electrode laminate body 101 is provided as shown in FIG. 2A. Next, as shown in FIG. 2B, the preliminary electrode laminate body 101 is pressed at a temperature of 100° C. or higher and 200° C. or lower. By pressing the preliminary electrode laminate body 101, the densification of the preliminary electrode laminate body 101 can be performed. Moreover, as shown in FIG. 2C, the preliminary electrode laminate body 101 is caused to adsorb moisture, and the electrode laminate body 100 is generated, so that the solid-state battery 10 can be produced using the electrode laminate body 100.

Although not particularly limited, the method of producing the solid-state battery in the present disclosure may further include, after (b),
(b-2) forming a preliminary solid-state battery by disposing a current collector layer on a surface of the electrode laminate body, and
(b-3) pressing the preliminary solid-state battery at a temperature of 100° C. or higher and 200° C. or lower.

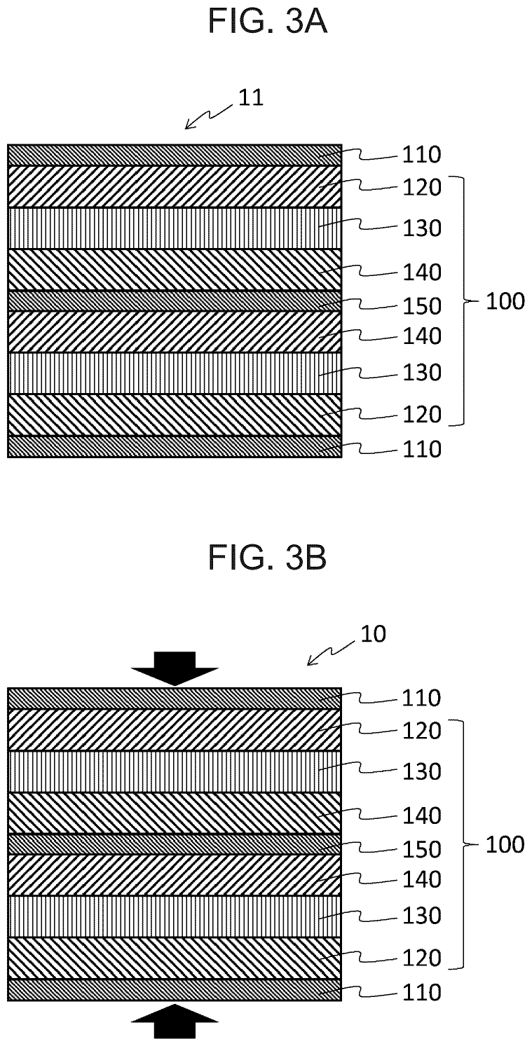

FIG. 3A and FIG. 3B are schematic sectional views showing an aspect of the method of producing the solid-state battery in the present disclosure, although not limited to this case.

As shown in FIG. 3A, for example, the positive electrode current collector layers 110 are disposed on surfaces of the positive electrode active material layers 120 of the electrode laminate body 100 in which the positive electrode active material layer 120, the solid electrolyte layer 130, the negative electrode active material layer 140, the negative electrode current collector layer 150, the negative electrode active material layer 140, the solid electrolyte layer 130, and the positive electrode active material 120 are laminated, and a preliminary solid-state battery 11 is formed. Next, as shown in FIG. 3B, the preliminary solid-state battery 11 is pressed at a temperature of 100° C. or higher and 200° C. or lower. By (b-2) and (b-3), the current collector layers can be provided on the surfaces of the electrode laminate body 100.

### Method of Adsorbing Moisture

As a method of causing the preliminary electrode laminate body to adsorb moisture, for example, by leaving the preliminary electrode laminate body for a predetermined time in a glove box or the like in which the humidity conditioning at a dew point of −50° C. has been performed, moisture can be adsorbed, although not limited to this case.

From the standpoint of the inhibition of the structure change of the solid electrolyte, the dew point in the environment for the adhesion of moisture to the preliminary electrode laminate body may be 0° C. or lower, −10° C. or lower, −30° C. or lower, or −50° C. or lower, and may be −80° C. or higher, −75° C. or higher, −70° C. or higher, or −65° C. or higher.

Although not particularly limited, the time for the adhesion of moisture to the preliminary electrode laminate body may be 30 seconds or more, 1 minute or more, 10 minutes or more, 30 minutes or more, or 1 hour or more, and may be 5 hours or less, 3 hours or less, 1 hour or less, or 30 minutes or less.

### Method of Pressing Preliminary Electrode Laminate Body

A method of pressing the preliminary electrode laminate body is not particularly limited, and roll press can be performed.

For example, the linear pressure for the press of the preliminary electrode laminate body may be 1 ton/cm or more, 3 ton/cm or more, or 5 ton/cm or more, and may be 10 ton/cm or less, 8 ton/cm or less, or 6 ton/cm or less.

For example, the temperature for the press of the preliminary electrode laminate body may be 100° C. or higher, 130° C. or higher, or 160° C. or higher, and may be 200° C. or lower, or 180° C. or lower.

### Method of Pressing Preliminary Solid-State Battery

A method of pressing the preliminary solid-state battery is not particularly limited, and press can be performed by pressurizing an upper surface and lower surface of the preliminary solid-state battery in the lamination direction.

For example, the pressure for the press of the preliminary solid-state battery may be 1 MPa or more, 3 MPa or more, or 5 MPa or more, and may be 100 MPa or less, 80 MPa or less, or 50 MPa or less.

For example, the temperature for the press of the preliminary solid-state battery may be 100° C. or higher, 120° C. or higher, or 140° C. or higher, and may be 200° C. or lower, 180° C. or lower, or 160° C. or lower.

Although not particularly limited, the time of the press of the preliminary solid-state battery may be 10 seconds or more, 1 minute or more, or 5 minutes or more, and may be 1 hour or less, 30 minutes or less, or 10 minutes or less.

The present disclosure will be described in more detail with reference to examples described below. The scope of the present disclosure is not limited to the examples.

### Measurement of Surface Moisture Amount

The surface moisture amount of the electrode laminate body was measured by punching the electrode laminate body such that 20 pieces having ϕ9.2 mm were obtained and taking the electrode laminate body in the Karl Fischer device (Karl Fischer device CA-310 and moisture vaporization device VA-300 manufactured by NITTOSEIKO CO., LTD.). Specifically, the electrode laminate body after punching was put in the moisture vaporization device VA-300 previously heated to 200° C., the moisture amount desorbed by heating was measured by the Karl Fischer device CA-310, and the surface moisture amount was evaluated. The measurement was ended when the detected moisture amount became 0.02 g/sec or less.

### Measurement of Whole Moisture Amount

The whole moisture amount of the electrode laminate body was measured by processing the electrode laminate body in a mortar such that powder was made and taking the obtained powder in the Karl Fischer device (Karl Fischer device CA-310 and moisture vaporization device VA-300 manufactured by NTTTOSEIKO CO., LTD.). Specifically, the above powder was put in the moisture vaporization device VA-300 previously heated to 200° C., the moisture amount desorbed by heating was measured by the Karl Fischer device CA-310, and the whole moisture amount was evaluated. The measurement was ended when the detected moisture amount became 0.02 g/sec or less.

### Example 1

### Production of Positive Electrode Active Material Layer Al

LiNi_{0.8}(CoAl)_{0.2}O₂ covered with a Li—Ti—Al—F material as a positive electrode active material, LiI—LiBr—Li₂S—P₂S₅ glass ceramics as a solid electrolyte, conductive carbon as a conduction aid, a binder, a dispersant, and an appropriate amount of solvent were mixed, dispersion treatment was performed by an ultrasonic homogenizer, and a positive electrode composite material slurry was prepared. Next, an aluminum foil was coated with the obtained positive electrode composite material slurry by die coating, drying was performed, and a positive electrode active material layer A1 was made on one surface of the aluminum foil.

### Production of Solid Electrolyte Layer B1

LiI—LiBr—Li₂S—P₂S₅ glass ceramics (average particle diameter: 2.5 μm) as a solid electrolyte, conductive carbon as a conduction aid, a binder, a dispersant, and an appropriate amount of solvent were mixed, dispersion treatment was performed by an ultrasonic homogenizer, and a solid electrolyte composite material slurry was prepared. Next, an aluminum foil was coated with the obtained solid electrolyte composite material slurry by die coating, drying was performed, and a solid electrolyte layer B1 was made on one surface of the aluminum foil.

### Production of Negative Electrode Active Material Layer C1

A Li₄Ti₅O₁₂ particle as a negative electrode active material, LiI—LiBr—Li₂S—P₂S₅ glass ceramics as a solid electrolyte, conductive carbon as a conduction aid, a binder, a dispersant, and an appropriate amount of solvent were mixed, dispersion treatment was performed by an ultrasonic homogenizer, and a negative electrode composite material slurry was prepared. Next, both surfaces of an aluminum foil as a negative electrode current collector were coated with the obtained negative electrode composite material slurry by die coating, drying was performed, and negative electrode active material layers C1 were made on both surfaces of the aluminum foil. The coating weight of the negative electrode active material layer was adjusted such that the charge specific capacity of the positive electrode active material layer was 200 mAh/g and the charge specific capacity of the negative electrode active material layer was one time of the charge specific capacity of the positive electrode active material layer.

### Production of Electrode Laminate Body D1

Solid electrolyte layers B1 were laid over the respective surfaces of negative electrode active material layers C1 formed on both surfaces of the aluminum foil as the negative electrode current collector, and were pressed. Thereby, the solid electrolyte layers B1 were transferred to the surfaces of the negative electrode active material layers C1, the aluminum foils contacting with the solid electrolyte layers B1 were peeled, and the solid electrolyte layers B1 were laminated on the negative electrode active material layers C1. Next, positive electrode active material layers Al were laid over the respective surfaces of the solid electrolyte layers B1 laminated on both surfaces of the negative electrode active material layers C1, and were pressed. Thereby, the positive electrode active material layers Al were transferred to the surfaces of the solid electrolyte layers B1, the aluminum foils contacting with the positive electrode active material layers Al were peeled, and the positive electrode active material layers Al were laminated on the solid electrolyte layers B1. The roll press of the made electrode laminate body was performed at 175° C. at 5 ton/cm, and thereby, a densified electrode laminate body was obtained. The densified electrode laminate body was left for 17 minutes in a humidity-conditioning glove box in which the dew point was set to −50° C., and a densified electrode laminate body D1 having adsorbed moisture was obtained. As for the densified electrode laminate body D1, the surface moisture amount was 251.7 ppm, the whole moisture amount was 259.3 ppm, and the ratio of the surface moisture amount to the whole moisture amount was 0.97.

### Production of Solid-State Battery E1

Carbon-coated aluminum foils as positive electrode current collectors were disposed on the respective surfaces of the positive electrode active material layers Al of the densified electrode laminate body D1, and were pressed at 140° C. at 5 MPa for 5 minutes, so that an electricity generating element was obtained. In the electricity generating element, the positive electrode current collector layer, the positive electrode active material layer A1, the solid electrolyte layer B1, the negative electrode active material layer C1, the negative electrode current collector layer, the negative electrode active material layer C1, the solid electrolyte layer B1, the positive electrode active material layer A1, and the positive electrode current collector layer were laminated in this order. The obtained electricity generating element was enclosed by a laminate film, and was confined at 5 MPa, and a solid-state battery E1 was made.

### Direct-Current Resistance of Solid-State Battery E1 in Initial Period

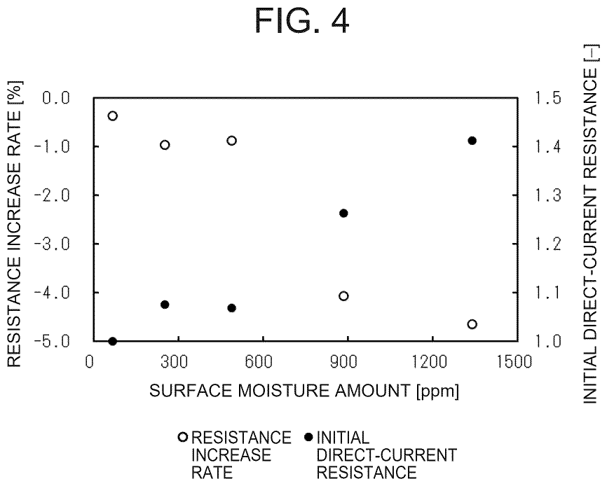

For the obtained solid-state battery E1, constant-current charge was performed at a current value corresponding to 0.3 C until the voltage became a voltage corresponding to a charge level of 40%, and next, constant-voltage charge was performed until the electric current became 0.01 C. Thereafter, for the solid-state battery E1, constant-current discharge was performed at a current value corresponding to 72 C, the difference between a voltage before discharge and a voltage after discharge for 0.1 seconds was divided by a current amount corresponding to 72 C, and the direct-current resistance (Q) of the solid-state battery E1 in an initial period was calculated. The direct-current resistance of the solid-state battery E1 in the initial period is shown in Table 1 and FIG. 4. The value of the direct-current resistance in the initial period in Table 1 is a relative value when the direct-current resistance of a solid-state battery e1 in Comparative Example 1 in the initial period is 1.00.

### Resistance Increase Rate of Solid-State Battery E1

For the solid-state battery E1, constant-current charge was performed at a current value corresponding to 0.3 C until the voltage became a voltage corresponding to a charge level of 40%, and next, constant-voltage charge was performed until the electric current became 0.01 C. Thereafter, the solid-state battery E1 was disposed in a constant-temperature bath in which the temperature was set to 60° C., and was preserved for two weeks. The direct-current resistance of the solid-state battery E1 was measured before and after the preservation in the constant-temperature bath, and the resistance increase rate (%) of the solid-state battery E1 based on durability was calculated by dividing the difference between the value of the direct-current resistance after the preservation and the value of the direct-current resistance before the preservation by the value of the direct-current resistance before the preservation and multiplying the resulting value by 100. The resistance increase rate of the solid-state battery E1 is shown in Table 1 and FIG. 4.

### Examples 2 to 4

### Production of Electrode Laminate Bodies D2 to D4

Electrode laminate bodies D2 to D4 were made by the same method as Example 1, except that densified electrode laminate bodies were left for predetermined times in glove boxes in which the dew point was set as described in Table 1, instead of leaving the densified electrode laminate bodies for 17 minutes in the humidity-conditioning glove box in which the dew point was set to −50° C. As for the electrode laminate bodies D2 to D4, the surface moisture amount, the whole moisture amount, and the ratio of the surface moisture amount to the whole moisture amount are shown in Table 1 and FIG. 4.

### Production of Solid-State Batteries E2 to E4, and Direct-Current Resistances and Resistance Increase Rates of Solid-State Batteries E2 to E4

Solid-state batteries E2 to E4 were made by the same method as Example 1, except that the electrode laminate bodies D2 to D4 were used instead of the electrode laminate body D1. For the solid-state batteries E2 to E4, the direct-current resistance in the initial period and the resistance increase rate were evaluated by the same method as Example 1. The respective results are shown in Table 1 and FIG. 4.

### Comparative Example 1

### Production of Electrode Laminate Body d1

An electrode laminate body d1 was made by the same method as Example 1, except that a densified electrode laminate body was not left in the humidity-conditioning glove box in which the dew point was set to −50° C. and intentional moisture adsorption was not performed. As for the electrode laminate body d1, the surface moisture amount, the whole moisture amount, and the ratio of the surface moisture amount to the whole moisture amount are shown in Table 1.

### Production of Solid-State Battery e1, and Direct-Current Resistance and Resistance Increase Rate of Solid-State Battery e1

A solid-state battery e1 was made by the same method as Example 1, except that the electrode laminate body d1 was used instead of the electrode laminate body D1. For the solid-state battery e1, the direct-current resistance in the initial period and the resistance increase rate were evaluated by the same method as Example 1. The respective results are shown in Table 1.

TABLE 1

| | | Comparative | | | | |
|---|---|---|---|---|---|---|
| | | Example 1 | Example 1 | Example 2 | Example 3 | Example 4 |
| Electrode Laminate Body | | Electrode | Electrode | Electrode | Electrode | Electrode |
| | | Laminate | Laminate | Laminate | Laminate | Laminate |
| | | Body d1 | Body D1 | Body D2 | Body D3 | Body D4 |
| Moisture | Dew Point [° C.] | — | −50 | −50 | −50 | −40 |
| Adsorption | Time [min] | — | 17 | 54 | 150 | 40 |
| Condition | | | | | | |
| Moisture | Surface | 66.3 | 251.7 | 489.2 | 1338.5 | 884.3 |
| Amount | Moisture | | | | | |
| | Amount [ppm] | | | | | |
| | Whole Moisture | 188.1 | 259.3 | 503.7 | 1458.2 | 973.2 |
| | Amount [ppm] | | | | | |
| | Ratio of Surface | 0.35 | 0.97 | 0.97 | 0.92 | 0.91 |
| | Moisture | | | | | |
| | Amount to | | | | | |
| | Whole Moisture | | | | | |
| | Amount | | | | | |
| Solid-State Battery | | Solid-State | Solid-State | Solid-State | Solid-State | Solid-State |
| | | Battery e1 | Battery E1 | Battery E2 | Battery E3 | Battery E4 |
| Evaluation | Initial | 1.00 | 1.08 | 1.07 | 1.41 | 1.26 |
| Result | Direct-Current | | | | | |
| | Resistance [Ω] | | | | | |
| | Resistance | −0.37 | −0.96 | −0.88 | −4.65 | −4.07 |
| | Increase Rate | | | | | |
| | [%] | | | | | |

In Examples 1 to 4, in the solid-state batteries E1 to E4 including electrode laminate bodies that contained predetermined amounts of surface moisture, it was possible to decrease the resistance increase rate of the battery based on durability without significantly increasing the direct-current resistance in the initial period. Furthermore, in the solid-state batteries E1, E2 in Examples 1 and 2, it was possible to decrease the resistance increase rate while the direct-current resistance in the initial period was hardly increased. On the other hand, in the solid-state battery e1 in Comparative Example 1, in which surface moisture was not adsorbed intentionally, the ratio of the surface moisture amount to the whole moisture amount was low. Therefore, the direct-current resistance in the initial period was small, but the effect of reducing the resistance increase rate, that is, the effect of easily decreasing the direct-current resistance of the battery due to durability was small. FIG. 4 shows the relation of the surface moisture amount, the initial direct-current resistance, and the resistance increase rate for the solid-state batteries in the examples and the comparative example.

Although details are not clear, it is presumed that when the electrode laminate body in which each of the positive electrode active material layer, the solid electrolyte layer, and the negative electrode active material layer contained the sulfide solid electrolyte adsorbed a predetermined amount of moisture, the moisture adsorbed in the electrode laminate body permeated to an interface between the positive electrode active material layer and the solid electrolyte layer, a reaction layer having a moderate thickness was formed at the interface, and the oxidative decomposition of the sulfide solid electrolyte at the time of charge was inhibited, so that it was possible to decrease the resistance increase rate based on durability without significantly increasing the direct-current resistance in the initial period.

Preferred embodiments of the solid-state battery and the method of producing the solid-state battery in the present disclosure have been described. A person skilled in the art understands that modifications can be made without departing from the scope of the claims.

What is claimed is:

1. A solid-state battery comprising an electrode laminate body in which a positive electrode active material layer, a solid electrolyte layer, and a negative electrode active material layer are laminated in this order, wherein:
each of the positive electrode active material layer, the solid electrolyte layer, and the negative electrode active material layer contains a sulfide solid electrolyte;
a surface moisture amount of the electrode laminate body is 200 ppm to 1500 ppm; and
a ratio of the surface moisture amount to a whole moisture amount in a whole of the electrode laminate body is 0.50 to 1.00.

2. The solid-state battery according to claim 1, wherein the surface moisture amount of the electrode laminate body is 200 ppm to 600 ppm.

3. A method of producing the solid-state battery according to claim 1, the method comprising:
(a) providing a preliminary electrode laminate body in which the positive electrode active material layer, the solid electrolyte layer, and the negative electrode active material layer are laminated in this order; and
(b) generating the electrode laminate body by keeping the preliminary electrode laminate body for 30 seconds or more in an environment in which a dew point is −80° C. or higher and 0° C. or lower, and causing the preliminary electrode laminate body to adsorb moisture.

4. The method according to claim 3, the method further comprising, between (a) and (b),
(a-2) pressing the preliminary electrode laminate body at a temperature of 100° C. or higher and 200° C. or lower.

5. The method according to claim 3, the method further comprising, after (b),
(b-2) forming a preliminary solid-state battery by disposing a current collector layer on a surface of the electrode laminate body; and
(b-3) pressing the preliminary solid-state battery at a temperature of 100° C. or higher and 200° C. or lower.
